(19) United States
(12) Patent Application Publication
(10) Pub. No.: US 2019/0268235 A1
(43) Pub. Date: Aug. 29, 2019

(54) METHOD FOR MANAGING NETWORK NODES AND COMMUNICATION CONTROL METHOD THEREOF

(71) Applicant: PLCT System Ltd., Surrey (CA)

(72) Inventors: Chuan ZHENG, Xiamen (CN); Wenbin LIN, Xiamen (CN); Wei LIN, Xiamen (CN)

(21) Appl. No.: 16/261,378

(22) Filed: Jan. 29, 2019

(30) Foreign Application Priority Data
Feb. 28, 2018 (CN) 201810166580

(51) Int. Cl. H04L 12/24; H04L 12/44

(52) U.S. Cl. CPC H04L 41/12; H04L 12/44

(57) ABSTRACT

The disclosure provides a method for managing network nodes and a communication control method thereof, and relates to the technical field of network communication. The nodes in a network adopt a bus distributed structure in a real physical structure, and all the nodes may communicate with each other. The nodes in the network logically adopt a tree structure, a root node is at the highest level, nodes of the first level are the extension of the root node, and so on, nodes of each level are the extension of the father nodes of the previous level. According to the disclosure, the nodes physically adopt a bus distributed structure, even if a certain node fails, the operation of the whole network will not be affected, and the robustness of system operation is guaranteed; logically, the relationship of different nodes is represented by a tree structure, which makes it is easy to traverse the data structure of the whole system; a data storage structure in the nodes is simplified by a white list mode; the complexity of synchronous control of all the nodes in the tree structure is simplified by means of the broadcast communication control of a white list; and the success rate of synchronous control of the nodes is improved through the skip communication mode of the nodes.

### FIELD OF THE TECHNOLOGY

The disclosure relates to the field of network communication, in particular to a method for managing network nodes and a communication control method thereof.

### BACKGROUND

Network topology structure refers to the physical layout of various devices interconnected by transmission media, and represents the specific physical (real) or logical (virtual) arrangement manners of members constituting a network. If two networks have the same connection structure, their network topologies are the same, although their internal physical wiring or the distance between nodes may be different.

There are three types of communication between network nodes: the first one is unicast, in which information is received and transmitted between two nodes only; the second one is multicast, in which one node delivers messages to multiple nodes; and the third one is broadcast, in which messages sent by one node may be received by all nodes in the whole network.

Current network topology structures are as follows:

A star structure, which means all nodes are connected into a network in a star manner. The network has a central node; all other nodes are connected to the central node directly. The star structure is centered on the central node and is therefore also called a centralized network. The star structure has the following advantages: simple structure and easy to manage; easy to control and conductive to establishing network; and short network delay time and small transmission error. The structure has the disadvantages following: high cost, low reliability and poor resource sharing ability.

A ring structure is a closed ring formed by a plurality of nodes in a network through end-to-end connection of point-to-point links. The ring structure enables common transmission cables to form ring connection. Data are transmitted between nodes along one direction in the ring, and information is transmitted from one node to another. The advantage of the ring structure is that each node is connected to two nodes in two directions at the same time, there is always a way which works, so the ring topology is naturally fault-tolerant. The disadvantage of the ring structure is that because there are data flows from two directions, the two directions must be distinguished or restricted in order to avoid interference of indistinguishable redundant data flows to normal communication, so management and maintenance of the ring structure are complicated.

A bus structure means that all workstations and servers are hung on one bus, all the workstations are equal in status, and there is no central node. The information on the public bus is usually transmitted serially in the form of baseband, and its transmission direction is always from the node sending the information to both ends, just like a radio station. Therefore, it is also called broadcast computer network. When receiving information, each node conducts address check to see if the address matches its workstation address, and then receives the information on the network if so. The bus structure has the following advantages: simple structure and good expandability. The disadvantages are that maintaining is difficult and the single-point structure may affect the whole network.

A distributed network structure is a form of network in which computers distributed in different locations are interconnected by communication lines. The distributed network structure has the advantage that due to decentralized control, the operation of the whole network will not be affected even if a local fault occurs, so reliability is quite high. The shortest path algorithm is adopted on the paths in the network, so network delay time is short, the transmission rate is high, but control is complicated. A data link can be directly established between nodes to realize the shortest information flow, which is conductive to sharing resources throughout the network. The disadvantages of the distributed network structure are that cables for connecting communication lines are long and the cost is high; network management software is complex; packet switching, path selection and flow control are complex; and distributed network structure is not used in general local area networks.

A tree structure is a hierarchical centralized control network with short total length of communication lines, low cost, easy to expand nodes and convenient to find path. However, except for leaf nodes and their connected lines, malfunction of any node or its connected lines will affect the system.

### SUMMARY

In order to solve the shortcomings of the network topology structures in the prior art, the disclosure provides a method for managing network nodes.

adopting, by nodes in a network, a bus distributed structure in a real physical structure, wherein, all the nodes may communicate with each other.

adopting, by the nodes in the network, a tree structure logically, wherein, a root node is at the highest level, nodes of the first level are the extension of the root node, and so on, nodes of each level are the extension of the father nodes of the previous level.

Preferably, the nodes in the network send a communication command by a mode of broadcasting.

Preferably, the structure of the communication command comprises a node address, a control command, and check information.

Preferably, the nodes in the network store addressing information, namely a white list, and the white list stores its own address information in an initial state.

Preferably, after a node in the network becomes a child node, the white list stores address information of all the nodes on the path from the root node to the child node itself.

Preferably, the nodes in the network logically constitute different tree structures mutually independent logically each of the tree structures has different root nodes, and each node is in one tree structure only.

The disclosure also provides a communication control method for network nodes, comprising the following steps:

S1, sending, by a certain node in a tree structure, a communication command, a node address in the communication command is an address of a node at the highest level in a node white list, that is, the address of a root node;

S2, analyzing, by other nodes analyze whether the node address in the communication command is consistent with the address of the node at the highest level stored in the white list, after monitoring the communication command;

S3, analyzing and responding a control command on condition that the node address in the communication command is consistent with the address of the node at the highest level stored in the white list;

S4, stopping analyzing and making no reaction on condition that the node address in the communication command is not consistent with the address of the node at the highest level stored in the white list; and

S5, responding, by all nodes in the tree structure, to the same control command, to realize synchronous control.

Preferably, all of the nodes have a communication skip function and only skip in response to communication commands of the same tree structure, but do not respond to communication commands of different tree structures.

Preferably, when an external communication command is sent to one of the nodes in the tree structure or a communication command is sent between nodes in the tree structure, a near-end node monitoring the communication command first not only responds to the control command, but also transmits the communication command.

The management method for network nodes and the communication control method thereof provided by the disclosure have the beneficial effects that: 1. the nodes adopt a bus distributed structure physically, even if a certain node fails, the operation of the whole network will not be affected, and the robustness of system operation is guaranteed; 2. the relationship of different nodes is represented by a tree structure logically, which makes it is easy to traverse the data structure of the whole system; 3. a data storage structure in the nodes is simplified by a white list mode; 4. the complexity of synchronous control of all the nodes in the tree structure is simplified by means of the broadcast communication control of the white list; and 5. the success rate of synchronous control of the nodes is improved through the skip communication mode of the nodes.

### BRIEF DESCRIPTION OF THE DRAWINGS

FIG. 1 is a diagram illustrating the interconnection relationship of network nodes.

### DETAILED DESCRIPTION

To further illustrate various embodiments, the present disclosure provides the accompanying drawings. These drawings disclose part of the present disclosure and are mainly used to illustrate embodiments of the present disclosure and to explain the operation principle of the embodiments in conjunction with the relevant description of the specification. With reference to the embodiments of the present disclosure, those of ordinary skill in the art will be able to understand other possible embodiments and advantages of the present disclosure. The components in the accompanying drawings are not drawn to scale, and similar component symbols are usually used to indicate similar components.

The present disclosure will now be further explained with reference to the drawings and specific embodiments.

An embodiment of the present disclosure provides a method for managing network nodes, wherein:

A) The nodes in a network adopt a bus distributed structure in a real physical structure, and all the nodes can communicate with each other; the nodes in the network send a communication command by broadcasting; and the structure of the communication command includes a node address, a control command, and check information.

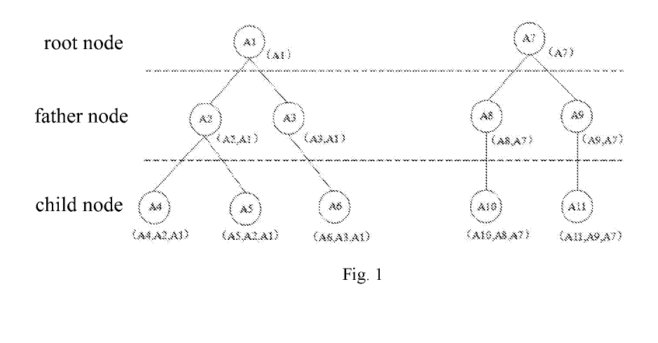

B) The nodes in the network adopt a tree structure logically, as shown in FIG. 1, a root node is at the highest level, nodes of the first level are the extension of the root node, and so on, nodes of each level are the extension of the father nodes of the previous level. Each node stores addressing information, called white list, which stores its own address information in an initial state. When a node in the network becomes a child node, the white list of its father node is completely copied into the white list of child nodes in the corresponding layer, and so on, each node stores address information of all the nodes on the path from the root node to the child node itself in a certain order. Starting from its own address of a certain node, the extended path of the node in the tree structure may be traversed, until the root node at the highest level.

Besides, the nodes in the network constitute different tree structures mutually independent logically, each of the tree structures has different root nodes, and each node is in one tree structure only.

A communication control method for network nodes provided by the embodiment of the present disclosure comprises the following steps:

S1, a certain node in a tree structure sends a communication command, and a node address in the communication command is an address of a node at the highest level in a node white list, that is, the address of a root node;

S2, after hearing the communication command, other nodes analyze whether the node address in the communication command is consistent with the address of the node at the highest level stored in the white list;

S3, continue to analyze and respond to a control command on condition that the node address in the communication command is consistent with the address of the node at the highest level stored in the white list;

S4, stop analyzing and to making no reaction on condition that the node address in the communication command is not consistent with the address of the node at the highest level stored in the white list;

and S5, all nodes in the tree structure respond to the same control command to realize synchronous control.

All the nodes have a communication skip function and only skip in response to communication commands of the same tree structure, but do not respond to communication commands of different tree structures. When an external communication command is sent to one of the nodes in the tree structure or a communication command is sent between nodes in the tree structure, a near-end node monitoring the communication command first not only responds to the control command, but also transmits the communication command. Through this skip mode, it can be ensured that a far-end node can also receive a communication command with high signal strength, thereby improving the success rate of the control of communication commands over all nodes in the tree structure.

Through the communication control method of the present embodiment, when a certain node fails, since the node physically exists in a bus distributed structure and communication commands do not need to be transmitted through the node logically, the communication between other nodes will not be affected and the robustness of system operation is guaranteed.

Although the present disclosure has been particularly shown and described in connection with preferred embodiments, it will be understood by those skilled in the art that various changes in form and details may be made therein without departing from the spirit and scope of the present disclosure as defined in the appended claims, all of which are within the scope of protection of the present disclosure.

What is claimed is:

1. A method for managing network nodes, comprising:
adopting, by nodes in a network, a bus distributed structure in a real physical structure; wherein, all the nodes communicate with each other; and
adopting, by the nodes in the network, a tree structure logically; wherein, a root node is at the highest level, nodes of the first level are the extension of the root node, and so on, nodes of each level are the extension of the father nodes of the previous level.

2. The method for managing network nodes according to claim 1, wherein, the nodes in the network send a communication command by a mode of broadcasting.

3. The method for managing network nodes according to claim 2, wherein, the structure of the communication command comprises a node address, a control command, and check information.

4. The method for managing network nodes according to claim 1, wherein, the nodes in the network store addressing information, called a white list, and the white list stores its own address information in an initial state.

5. The method for managing network nodes according to claim 4, wherein, after a node in the network becomes a child node, the white list stores address information of all the nodes on the path from the root node to the child node itself.

6. The method for managing network nodes according to claim 5, wherein, the nodes in the network constitute different tree structures mutually independent logically, each of the tree structures has different root nodes, and each node is in one tree structure only.

7. A communication control method for network nodes based on the method according to claim 1, comprising:
S1, sending, by a certain node in a tree structure, a communication command, a node address in the communication command is an address of a node at the highest level in a node white list, that is, the address of a root node;
S2, analyzing, by other nodes whether the node address in the communication command is consistent with the address of the node at the highest level stored in the white list, after monitoring the communication command;
S3, analyzing and responding a control command on condition that the node address in the communication command is consistent with the address of the node at the highest level stored in the white list;
S4, stopping analyzing and making no reaction on condition that the node address in the communication command is not consistent with the address of the node at the highest level stored in the white list; and
S5, responding, by all nodes in the tree structure, to the same control command, to realize synchronous control.

8. The communication control method for network nodes according to claim 7, wherein, all of the nodes have a communication skip function and only skip in response to communication commands of the same tree structure, but do not respond to communication commands of different tree structures.

9. The communication control method for network nodes according to claim 7, wherein, when an external communication command is sent to one of the nodes in the tree structure or a communication command is sent between nodes in the tree structure, a near-end node monitoring the communication command first not only responds to the control command, but also transmits the communication command.
